(19) United States
(12) Patent Application Publication
(10) Pub. No.: US 2020/0186912 A1
(43) Pub. Date: Jun. 11, 2020

(54) AUDIO HEADSET DEVICE

(71) Applicants: Raphael BLOUET, Bordeaux (FR); INSTITUT MINES TELECOM, Paris (FR)

(72) Inventors: Slim ESSID, Arcueil (FR); Raphael BLOUET, Bordeaux (FR)

(21) Appl. No.: 16/462,691

(22) PCT Filed: Nov. 20, 2017
(86) PCT No.: PCT/FR2017/053183

§ 371 Date: Aug. 14, 2019

(30) Foreign Application Priority Data
Nov. 21, 2016 (FR) 16 61324

(51) Int. Cl. H04R 1/10; H04R 1/08; H04R 1/28

(52) U.S. Cl. CPC H04R 1/1083; H04R 1/1091; H04R 1/08; H04R 2410/05; H04R 2420/01; H04R 2460/01; H04R 1/2803

(57) ABSTRACT

The invention relates to data processing for sound playing on a sound playing device (DIS), headset or ear bud type, portable by a user in an environment (ENV). The device comprises at least one speaker (HP), at least one microphone (MIC), and a connection to a processing circuit comprising:
An input interface (IN) for receiving signals coming at least from the microphone;
A processing unit (PROC, MEM) for reading at least one audio content to play on the speaker; and
An output interface (OUT) for delivering at least the audio signals to be played by the speaker.

The processing unit is arranged for:
a) Analyzing the signals coming from the microphone for identifying sounds coming from the environment and corresponding to predetermined classes of target sounds;
b) Selecting at least one identified sound, according to a user preference criterion; and
c) Building said audio signals to be played by the speaker, by a selected mixing of the audio content and the selected sound.

### PRIORITY

This application is a U.S. National Stage Entry of PCT/FR2017/053183, entitled “Improved Audio Headset Device,” filed Nov. 20, 2017, which claims priority to FR 16 061324, filed Nov. 21, 2016, the disclosures of which are incorporated by reference herein.

### FIELD OF THE INVENTION

The invention relates to a portable audio listening device. It can involve an audio headset with left and right earphones or left and right portable earbuds.

### BACKGROUND OF THE INVENTION

Anti-noise audio headsets are known, based on capturing the user's sound environment with a microphone array. In general, these devices seek to build, in real time, the optimal filter with which to maximally reduce the contribution of the sound environment in the sound signal perceived by the user. An environmental noise filter was recently proposed which can be a function of the type of environment described by the user itself, who can then select various noise cancellation modes (e.g. office, outside, etc.). In this case, the “outside” mode can provide a reinjection of the environmental signal (but at a much lower level than without the filter, and do so in a way that allows the user to remain aware of their environment).

Also selective audio headsets and earbuds are known allowing personalized listening to the environment. Having appeared recently, these products serve to modify the perception of the environment along two axes:
The increase of perception (intelligibility of speech), and
The protection of the auditory system from environmental noise.

It can involve audio earphones, configurable by a smart phone application. Speech amplification is possible in a noisy environment, since speech is generally located in front of the user.

It can also involve audio earphones connected to a smartphone allowing the user to configure their perception of the sound environment: adjust the volume, add an equalizer or sound effects.

Thus, interactive headsets and earphones can be cited, for augmented reality, with which to enrich the sound environment (games, historic reconstitution) or guide an activity of the user (virtual coach).

Finally, the methods used by some auditory prostheses for improving the experience of the hard of hearing user offer directions for innovation such as improving spatial selectivity (e.g. following the direction of the eyes of the user).

However, these various existing implementations do not allow:
Analyzing and interpreting the activity of the user, nor the content they consume, nor the environment (in particular the soundscape) in which they are immersed;
Automatically modifying the audio rendering depending on the result of these analyses.

Typically, anti-noise headsets are based on an exclusively sonic multichannel capture of the user's environment. They seek to globally reduce the contribution thereof in the signal perceived by the user independently of the nature of the environment and do this even if they contain potentially interesting information. These devices therefore tend to isolate the user from their environment.

The selective prototypes of audio headsets allow the user to configure their sound environment by applying equalization filters or by increasing speech intelligibility. With these devices the perception of the user's environment can be improved, but the devices do not really allow modifying the content produced depending on the user's state or classes of sound present in the environment. In this configuration, the user listening to music at a loud volume is always isolated from their environment and there is always a need for a device allowing the user to capture pertinent information in their environment.

Of course, interactive headsets and earphones can be equipped with sensors with which to load and produce content associated with the location (in connection with tourism for example) or an activity (game, sports training). While some devices even have inertial or physiological sensors for monitoring the user's activity and while production of some content can then depend on the results of the analysis of signals coming from these sensors, the content produced does not result from a process of automatic generation incorporating the analysis of the soundscape surrounding the user and does not allow automatically selecting components of this environment pertinent to the user. Further, the modes of operation are static and do not automatically follow the changes over time of the sound environment and even less other changing parameters such as for example a physiological state of the user.

### SUMMARY OF THE INVENTION

The present invention seeks to improve the situation.

For this purpose, it proposes a method implemented by computer means of data processing for sound playing on a sound-playing device, headset or ear bud type, portable by a user in an environment, the device comprising:
At least one speaker;
At least one microphone;
A connection to a processing circuit;

The processing circuit comprising:
An input interface for receiving signals coming at least from the microphone;
A processing unit for reading at least one audio content to play on the speaker; and
An output interface for delivering at least the audio signals to be played by the speaker.

In particular, the processing unit is further arranged to implement the steps:

a) Analyzing the signals coming from the microphone for identifying sounds coming from the environment and corresponding to predetermined classes of target sounds;

b) Selecting at least one identified sound, according to a user preference criterion; and

c) Building said audio signals to be played by the speaker, by a selected mixing of the audio content and the selected sound.

In a possible embodiment, the device comprises a plurality of microphones and the analysis of the signals coming from the microphones further comprises a processing applied to the signals coming from the microphones for separation of sound sources from the environment.

For example, in step c), the selected sound can be:
Analyzed at least in frequency and duration;
Enhanced by filtering after processing for separation of sources, and mixed with the audio content.

In an embodiment where the device comprises at least two speakers and the playing of the signals on the speakers applies a 3D sound effect, a sound source position detected in the environment and issuing a selected sound, can be considered for applying a sound spatialization effect to the source in the mixing.

In an embodiment, the device can further comprise a connection to a human machine interface made available to a user for entering preferences for selection of sounds from the environment (in a broad meaning, as will be seen later) and the user preference criterion is then determined by learning from a history of preferences entered by the user and stored in memory.

In an (alternative or additional) embodiment, the device can further comprise a connection to a database of user preferences and the user preference criterion is then set by the analysis of the content of said database.

The device can further comprise a connection to one or more state sensors for a user of the device, such that the user preference criterion considers a current state of the user, then contributing to a definition of the user's “environment”, in a broad meaning.

In such an environment, the device can comprise a connection to a mobile terminal available to the user of the device, this terminal advantageously comprising one or more sensors of the user's state.

The processing unit can further be arranged for selecting content to be read from among a plurality of content, depending on the sensed state of the user.

In an embodiment, the classes of predetermined target sounds can comprise at least speech sounds, for which voice prints are prerecorded.

Further, as an example, step a) can optionally comprise at least one of the following operations:
Construction and application of a dynamic filter for noise cancellation in the signals coming from the microphone;
Localization and isolation of sound sources from the environment by applying source separation processing to signals coming from several microphones and for example using beamforming for identifying sources of interest (for the user of the device);
Extraction of parameters specific to these sources of interest in order for later playing in spatialized audio mixing of captured sounds coming from these sources of interest;
Identification of various classes of sound corresponding to the sources (in different spatial directions) by a classification system (for example by deep neural networks) for known classes of sound (speech, music, noise, etc.);
And possible identification by other techniques for classification of the soundscape (for example sound recognition of an office, outside street, mass transit, etc.).

Further, as examples, step c) can optionally comprise at least one of the following operations:
Temporal, spectral and/or spatial filtering (for example Weiner filtering and/or Duet algorithm), for enhancing a given sound source from one or more audio flows captured by a plurality of microphones (based on parameters extracted by the aforementioned source separation module);
3D audio rendering, for example using HRTF (Head Related Transfer Function) filtering techniques.

The present invention also targets a computer program comprising instructions for implementation of the above method when this program is executed by a processor.

The invention also targets a sound-playing device, headset or ear bud type, portable by a user in an environment, the device comprising:
At least one speaker,
At least one microphone;
A connection to a processing circuit;

The processing circuit comprising:
An input interface for receiving signals coming at least from the microphone;
A processing unit for reading at least one audio content to play on the speaker; and
An output interface for delivering at least the audio signals to be played by the speaker.

The processing unit is further arranged for:
Analyzing the signals coming from the microphone for identifying sounds coming from the environment and corresponding to predetermined classes of target sounds;
Selecting at least one identified sound, according to a user preference criterion; and
Building said audio signals to be played by the speaker, by a selected mixing of the audio content and the selected sound.

The invention thus proposes a system including an intelligent audio device, incorporating for example a network of sensors, at least one speaker and a terminal (e.g. smart phone).

The originality of this system is to be able to automatically manage in real time the “optimal soundtrack” for the user, meaning the multimedia content best suited to their environment and their own condition.

The user's own condition can be defined by:

i) a collection of preferences (type of music, classes of sound of interest, etc.);

ii) their activity (at rest, at the office, in sports training, etc.);

iii) their physiological states (stress, fatigue, effort, etc.) and/or socio-emotional (personality, mood, emotions etc.).

The multimedia content generated can comprise a main audio content (to be produced in the headset) and possibly secondary multimedia content (texts, images, video) which can be played through a smart phone type terminal.

The various items of content combine items from the base of user content (music, video, etc. stored on the terminal or in the cloud), the result of captures done by a network of sensors that the system comprises and synthesized elements generated by the system (notifications, sound or text jingles, comfort noise, etc.).

Thus, the system can automatically analyze the environment of the user and predict the components potentially of interest for the user in order to play them in an augmented and controlled manner by optimally superimposing them on the content consumed by the user (typically music they listen to).

The effective playing of the content considers the nature of the content and the components extracted from the environment (along with the user's own condition in a more sophisticated embodiment). The sound flow produced in the headset no longer comes from two concurrent sources:
A main source (music or radio broadcast or other), and
A disturbing source (ambient noise),

But from a collection of information flows whose relative contributions are adjusted according to their pertinence.

Thus, a message broadcast within a train station will be played so that it can be clearly understood by the user even if the user is listening to the music at high volume, while also reducing the ambient noise not pertinent to the user. The addition of an intelligent processing module incorporating in particular algorithms for source separation and for soundscape classification makes this possible. The direct application advantage is both reconnecting the user with their environment and warning them if a class of target sounds is detected, and also automatically generating a content suited to the user's expectations at each moment because of a recommendation engine handling the various aforementioned content items.

It is appropriate to recall that the devices from the state-of-the-art do not allow automatically identifying each class of sound present in the user's environment for associating with each of them a processing consistent with the user's expectations (for example enhancing a sound, or in contrast reducing the sound level, generation of an alert) according to its identification in the environment. The state-of-the-art does not use analysis of the soundscape, nor the user's state or their activity for calculating the sound rendering.

Other advantages and features of the invention will appear upon reading the following detailed description of sample embodiments and examining the attached drawings.

### BRIEF DESCRIPTION OF THE FIGURES

FIG. 1 shows a device according to the invention, in a first embodiment;

FIG. 2 shows a device according to the invention, in a second embodiment, here connected to a mobile terminal;

FIG. 3 shows the steps of a method according to an embodiment of the invention; and

FIG. 4 specifies the steps for the method from FIG. 3, according to a specific embodiment.

### DESCRIPTION

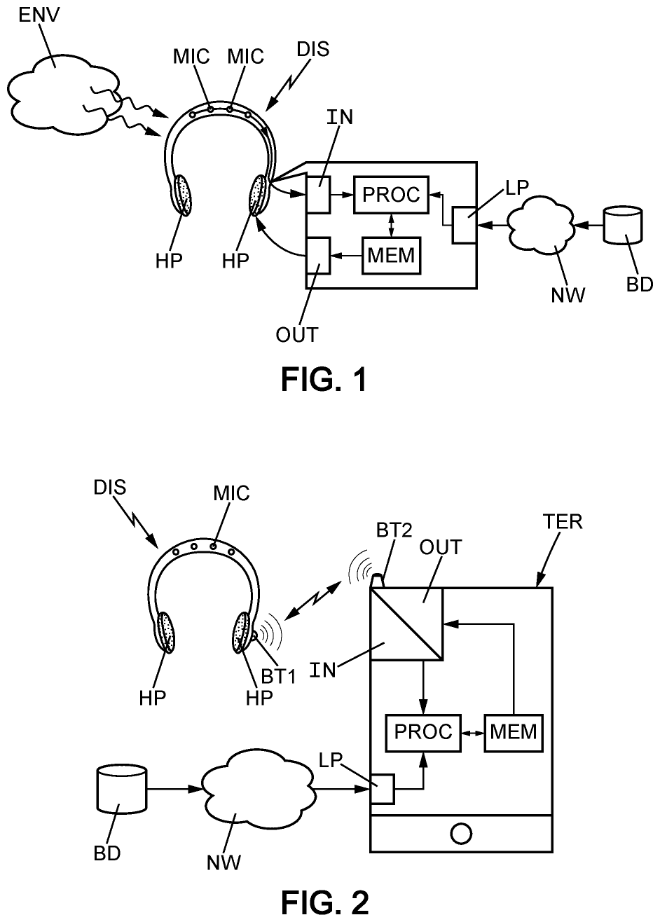

Referring to FIG. 1, a (headset or ear bud type) sound playing device DIS, worn for example by a user in an environment ENV, the device comprising at least:
One (or two, in the example shown) speakers HP;
At least one sensor, for example a microphone MIC (or a row of microphones in the example shown for capturing the direction of the sound coming from the environment); and
A connection to a processing circuit.

The processing circuit can be directly incorporated in the headset and be housed in a speaker enclosure (as shown in FIG. 1), or can, in the variant shown in FIG. 2, be implemented in a user terminal TER, for example a smart phone type mobile terminal, or even be distributed between several user terminals (a smart phone and a connected object which could comprise other sensors). In this variant, the connection between the headset (or earbuds) and the dedicated processing circuit in the terminal is done by a USB or short range radiofrequency (for example Bluetooth or other) connection and the headset (or earbuds) is equipped with a BT1 transmitter/receiver communicating with a BT2 transmitter/receiver comprised in the terminal TER. A hybrid solution in which the processing circuit is distributed between the headset enclosure and a terminal is also possible.

In one or another of the above embodiments, the processing circuit comprises:
An input interface IN for receiving signals coming at least from the microphone MIC;
A processing unit typically comprising a processor PROC and memory MEM, for interpreting the signals coming from the microphone relative to the environment ENV for learning (for example by classification or even by fingerprinting type matching for example);
An output interface OUT for delivering at least the audio signals depending on the environment and to be played by the speaker.

The memory MEM can store instructions for a computer program in the meaning of the present invention and could store temporary data (calculation or other), along with long-term data, like for example user preferences or even template definition data or other data, as will be seen later.

In a sophisticated embodiment, the input interface IN is, connected to a microphone array, and also to an inertial sensor (provided on the headset or in the terminal).

The user preference data can be stored locally in the memory MEM as indicated above.

As a variant, they can be stored, possibly with other data, in a remote database DB accessible by communication over a local or wide area network NW. A communication module LP with such a network suited for this purpose can be provided in the headset or in a terminal TER.

Advantageously, the human machine interface can allow the user to define and implement their preferences. In the embodiment from FIG. 2 where the device DIS is paired with the terminal TER, the human machine interface can simply correspond to the smart phone TER touchscreen, for example. Otherwise, such an interface can be provided directly on the headset.

In the embodiment from FIG. 2, it is just the same advantageously possible to take advantage of the presence of additional sensors in the terminal TER to enrich the definition of the user's environment in the general sense. These additional sensors can be physiological sensors specific to the user (electroencephalogram measurement, heart rate measurement, pedometer, etc.) or any other sensors with which to improve the knowledge of the environment and current user state pair. Additionally, this definition can include the user directly reporting their activity, their own condition and their environment.

The definition of the environment can further consider:
The collection of accessible content and a history of the content consulted (music, videos, radio broadcasts, etc.);
Metadata (for example the type, listening events by segment) associated with the user's musical library can also be associated;
Additionally, the navigation and application history of their smart phone;
The history of their streaming (via a service provider) or local content consumption;
Their preferences and activity during connections to social networks.

Thus, the input interface can, in a general sense, be connected to a collection of sensors and also include connection modules (in particular the LP interface) for characterizing the user's environment, but also their habits and preferences (history of content consumption, streaming activities and/or social networks).

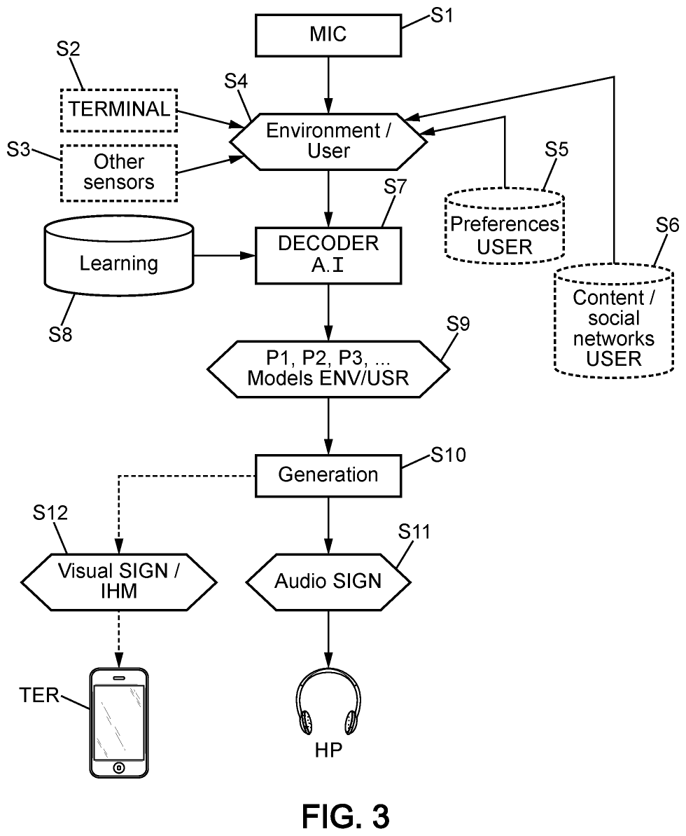

Referring to FIG. 3, the processing which the aforementioned processing unit does is described: monitoring the environment and possibly the user state for characterizing the information which is pertinent and could be played in the output multimedia flow. In an embodiment, this monitoring is implemented by automatic extraction of important parameters for the creation of the output multimedia flow through signal processing and artificial intelligence modules, in particular machine learning (represented by step S7 in FIG. 3). These parameters, noted P1, P2, etc., in the figures can typically be environmental parameters which should be considered for the playing on speakers. For example if a sound captured in the environment is identified as being a speech signal to play:
A first collection of parameters can be coefficients for an optimal filter (Weiner type filter) with which to enhance the speech signal for increasing the intelligibility thereof;
A second parameter is the directionality of the sound captured in the environment and to be played for example using binaural rendering (playing technique using HRTF type transfer functions);
etc.

It will thus be understood that these parameters P1, P2, etc. are to be interpreted as descriptors of the environment and the user's own condition in the general sense, which feed a program for generation of the “optimal soundtrack” for this user. This soundtrack is obtained by composition of its contents, items from the environment and synthetic items.

During the first step S1, the processing unit calls on the input interface for collecting the signals coming from the microphone or the microphone array MIC that is carried by the device DIS. Of course, other sensors (inertia, or other) in the terminal TER at step S2 or else at step S3 (connected sensors for heart rhythm, EEG, etc.) can communicate their signals to the processing unit. Additionally, data other than captured signals (preferably from the user at step S5 and/or the consumption history of content and social network connections at step S6) can be sent to the processing unit by the memory MEM and/or by the database BD in the processing unit.

At step S4, all these data and signals specific to the environment and the user's state (hereafter generically called “environment”) are collected and interpreted by the implementation, at step S7, of a computer module for decoding the environment by artificial intelligence. For this purpose, this decoding module can use a learning base which can, for example, be remote and called on in step S8 through the network NW (and the communication interface LP), in order to extract in step 9 pertinent parameters P1, P2, P3, etc. modelling the environment generally.

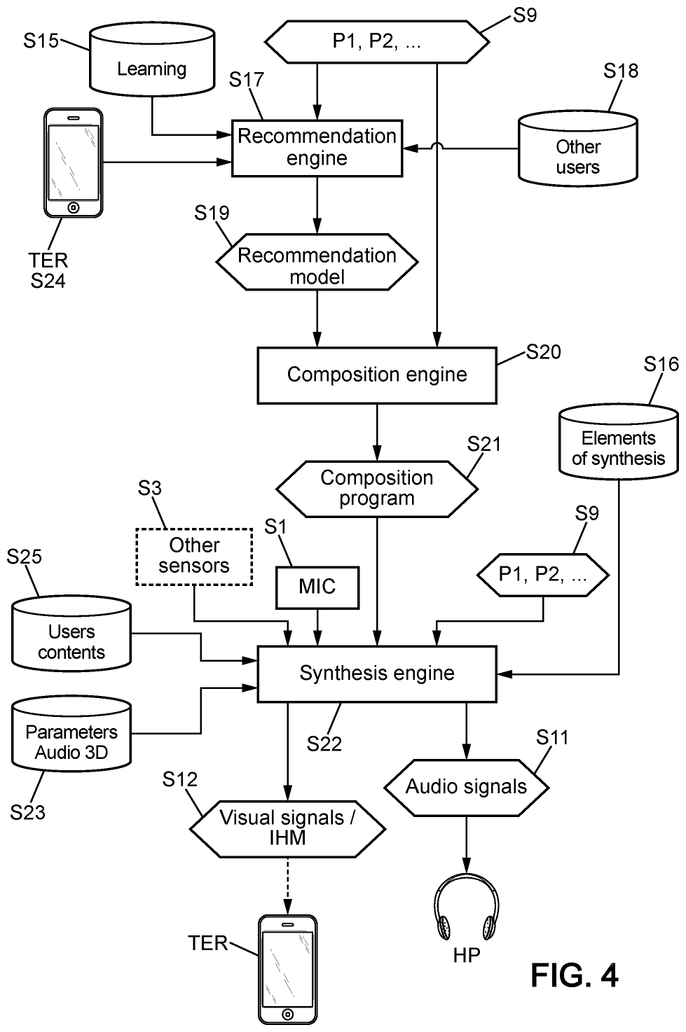

As detailed later with reference to FIG. 4, the soundscape to be played is generated from these parameters in particular at step S10 and sent in the form of audio signals to the speakers HP at step S11. This soundscape could be accompanied by graphic information, for example metadata, to be displayed on the terminal screen TER at step S12.

Thus an environmental signal analysis is done with:
An identification of the environment in order to estimate the prediction models with which to characterize the user's environment and their own condition (these models are used with a recommendation engine as will be seen later with reference to FIG. 4); and
A fine acoustic analysis with which to generate more precise parameters and serving to manipulate the audio content to be played (e.g. separation/enhancement of specific sound sources, sound effects, mixing, spatialization or others).

The identification of the environment serves to characterize, by automatic learning, the environment/user's own condition pair. Mainly, it involves:
Detecting whether some classes of target sounds, among several prerecorded classes, are present in the user's environment and determining, as appropriate, the direction of origin thereof. Initially, the classes of target sounds can be defined, one by one, by the user via their terminal or by using predefined modes of operation;
Determining the user's activity: resting, in the office, active in a gym, or other;
Determining the user's emotional and physiological state (for example “in shape” from a pedometer, or “stressed” from their EEG);
Describing the contents that the user consumes by means of techniques for analysis by the content (computer hearing and vision techniques and natural language processing).

The acoustic parameters, which are used for audio playing (for example in 3D playing), can be calculated from the fine acoustic analysis.

Now referring to FIG. 4, at step S17, a recommendation engine is used to receive the descriptors from the “environment”, in particular the classes of identified sound events (parameters P1, P2, etc.), and to provide on this basis a model for recommendations (or combination of models) at step S19. For this purpose, the recommendation engine can use the characterization of the user's contents and their similarity to external contents along with the user's preferences, which were entered in the learning base at step S15 and/or standard preferences of other users at step S18. At this step, the user can also act with their terminal for entering a preference at step S24, for example in connection with content or a list of content to play.

From the collection of these recommendations, a pertinent recommendation model is chosen based on the environment and the user's state (for example in the group of rhythmic music in situation of apparent movement of the user in a gym). A composition engine is next implemented in step S20, which combines the parameters P1, P2, etc. to the recommendation module for preparing a composition program in step S21. Here it involves a routine which for example suggests:
Looking for a specific type of content in the user's content;
Considering the user's own condition (for example their activity) and some types of sounds from the environment identified in the parameters P1, P2, etc.;
Mixing the content according to a sound level and a spatial rendering (3D audio) which was defined by the composition engine.

The synthesis engine, strictly speaking, for the sound signal gets involved in step S22 for preparing the signals to be played in steps S1 and S12, based on:
User content (coming from step S25 (as sub-step of step S6), of course one item of content was selected in step S21 by the composition engine);
Sound signals captured in the environment (S1, possibly parameters P1, P2, etc. in the case of synthetizing sounds from the environment to be played); and
Other sounds, possibly synthesized, for notifications (ping, ringer or other), which can announce an outside event and be mixed with the content to play (selected in step S21 from step S16),

possibly with a 3D rendering defined in step S23.

Thus, the flow generated is suited to the expectations of the user and optimized according to the context for its production, according to three main steps in a specific embodiment:
Using a recommendation engine for filtering and selecting in real time the items of content to mix for the sound playing (and possibly visual also) of a multimedia flow (called “controlled reality”);
Using a media composition engine which programs the temporal, frequency and spatial layout of the items of content, with respective sound levels also defined;
Using a synthesis engine generating the signals for sound rendering (and possibly visual), possibly with sound spatialization, according to the program established by the composition engine.

The multimedia flow generated comprises at least audio signals but potentially text, haptic or visual notifications. The audio signals include mixing of:
Content selected in the user's content base (music, video, etc.), entered as preferred by the user in step S24, or directly recommended by the recommendation engine depending on the user's state and the environment; Possibly with
Sounds captured by the sensor array MIC, selected in the sound environment (therefore filtered), enhanced (for example by source separation techniques) and treated so that it has a frequency texture, intensity and spatialization adjusted for being suitably injected into the mixing;
   and
Synthesized items retrieved from a database in step S16, for example sounds for sound or text notifications/jingles, comfort noise, etc.).

The recommendation engine is based jointly on:
The user's preferences obtained explicitly through a form of surveying or implicitly by making use of the result of decoding the user's own condition;
Techniques for collaborative filtering and social graphs, making use of models of several users at once (step S18);
The description of contents from the user and their similarity, in order to build models with which to decide what items of content should be played to the user.

Over time, the models are continuously updated for adapting to the user's changes.

The composition engine plans:
The moment at which each content item should be played, in particular the order in which the user's content is presented (for example, the order of music selections in a playlist), and the moments when outside sounds or notifications are played: in real time or delayed (for example between two selections from a playlist) for not disturbing the user's ongoing listening or activity at an inopportune time;
The spatial position (for 3D rendering) of each content item;
The various audio effects (gain, filtering, equalization, dynamic compression, echo or reverberation (“reverb”), time slowing/acceleration, transposition, etc.) which must be applied to each content item.

The plan is based on models and rules built from decoding of the user's environment and the user's own condition. For example, the spatial position of a sound event captured by the microphones and the gain level associated with it depend on the result of the sound sources localization detection that the environmental decoding does in step S7 of FIG. 3.

The synthesis engine relies on signal processing techniques, natural languages and images, respectively for synthesis of audio, text and visual (images or video) outputs, and jointly for generation of multimedia outputs, for example video.

In the case of synthesis of the audio output, temporal, spectral and/or spatial filtering techniques can be used. For example, the synthesis is first done locally on short time windows and the signal is rebuilt by addition-recovery before being sent to at least two speakers (one for each year). Gains (power levels) and various audio effects are applied to various content items such as provided by the composition engine.

In a specific embodiment, the processing applied by windows can include filtering (for example Wiener) with which to enhance a particular sound source (such as intended by the composition engine) from one or more captured audio flows. In a specific embodiment, the processing can include a 3D audio rendering, potentially using HRTF filtering techniques (HRTF transfer functions, “Head Related Transfer Functions”).

In a first example showing a minimal implementation,
The description of the user's environment is limited to their sound environment;
The user's own condition is limited to their preferences: class of target sound, notifications that they want to receive, these preferences being defined by the user using their terminal;
The device (possibly in cooperation with the terminal) is equipped with inertial sensors (accelerometer, gyroscope and magnetometer);
The playing parameters are automatically modified when a class of target sounds are detected in the user's environment;
Short messages can be recorded;
Notifications can be sent to the user to warn them of the detection of an event of interest.

The captured signals are analyzed in order to determine:
The classes of sounds present in the user's environment and the directions from which they come, with for that purpose:
Detection of the directions of strongest sound energy by analyzing the contents of each of these directions independently;
Overall determination for each direction of the contribution of each of the sound classes (for example by using a source separation technique);
Model parameters describing the environment of the user and parameters feeding the recommendation engine.

In a second example illustrating a more sophisticated implementation, a set of sensors including a microphone array, a video camera, pedometer, inertial sensors (accelerometers, gyroscopes, magnetometers), and physiological sensors can capture the visual and sound environment of the user (microphones and camera), the data characterizing their movement (inertial sensors, pedometer) and their physiological parameters (EEG, ECG, EMG, electrodermal) and also all content that they are consulting (music, radio broadcasts, videos, navigation history and their smart phone applications). Next, the various flows are analyzed for extracting information related to the user's activity, their mood, their degree of fatigue and their environment (for example treadmill at a gym, good mood and low level of fatigue). A musical flow suited to the environment and the user's own condition can be generated (for example a playlist for which each item is selected according to their musical tastes, their surrounding and the level of fatigue). Then all the sound sources are canceled in the user's headset, the voice of a sports coach near the user, when it is identified (previously recorded voice print), is mixed in the flow and played spatially using binaural rendering techniques (by HRTF for example).

1-11. (canceled)

12. A method implemented by computer means of data processing for sound playing on a sound-playing device, headset or ear bud type, portable by a user in an environment, the device comprising:
At least one speaker;
At least one microphone;
A connection to a processing circuit;
The processing circuit comprising:
An input interface for receiving signals coming at least from the microphone;
A processing unit for reading at least one audio content to play on the speaker; and
An output interface for delivering at least the audio signals to be played by the speaker,
Wherein the processing unit is further arranged to implement:
a) Analyzing the signals coming from the microphone for identifying sounds coming from the environment and corresponding to predetermined classes of target sounds;
b) Selecting at least one identified sound, according to a user preference criterion; and
c) Building said audio signals to be played by the speaker, by a selected mixing of the audio content and the selected sound,
And the device comprising a plurality of microphones, the analysis of the signals coming from the microphones further comprises a processing applied to the signals coming from the microphones for separation of sound sources from the environment.

13. The method according to claim 1, wherein, in step c), the selected sound is:
Analyzed at least in frequency and duration;
Enhanced by filtering after processing for separation of sources, and mixed with the audio content.

14. The method according to claim 1, wherein the device comprising at least two speakers and the playing of the signals on the speakers applying a 3D sound effect, a sound source position detected in the environment and issuing a selected sound, is considered for applying a sound spatialization effect to the source in the mixing.

15. The method according to claim 1, wherein the device comprises a connection to a human machine interface made available to a user for entering preferences for selection of sounds from the environment and the user preference criterion is determined by learning from a history of preferences entered by the user and stored in memory.

16. The method according to claim 1, wherein the device further comprises a connection to a database of user preferences and the user preference criterion is set by the analysis of the content of said database.

17. The method according to claim 1, wherein the device further comprises a connection to one or more state sensors for a user of the device, and the user preference criterion considers a current state of the user.

18. The method according to claim 6, wherein the device comprises a connection to a mobile terminal available to the user of the device, the terminal comprising one or more sensors of the user's state.

19. The method according to claim 6, wherein the processing unit is further arranged for selecting content to be read from among a plurality of content, depending on the state of the user.

20. The method according to claim 1, wherein the classes of predetermined target sounds comprise at least speech sounds, prerecorded voice prints.

21. A non-transitory computer storage medium, storing instructions of a computer program, to perform the method according to claim 1 when such instructions are run by a logical circuit.

22. A sound-playing device comprising at least one of a headset and ear bud, portable by a user in an environment, the device comprising:
At least one speaker;
At least one microphone;
A connection to a processing circuit;
The processing circuit comprising:
An input interface for receiving signals coming at least from the microphone;
A processing unit for reading at least one audio content to play on the speaker; and
An output interface for delivering at least the audio signals to be played by the speaker,
Characterized in that the processing unit being further arranged for:
Analyzing the signals coming from the microphone for identifying sounds coming from the environment and corresponding to predetermined classes of target sounds;
Selecting at least one identified sound, according to a user preference criterion; and
Building said audio signals to be played by the speaker, by a selected mixing of the audio content and the selected sound,
And the device comprising a plurality of microphones, the analysis of the signals coming from the microphones further comprises a processing applied to the signals coming from the microphones for separation of sound sources from the environment.
